(19) United States
(12) Patent Application Publication
(10) Pub. No.: US 2018/0182361 A1
(43) Pub. Date: Jun. 28, 2018

(54) Musical Instrument Protector

(71) Applicants: Donald Douglas Gandy, Hayden, ID (US); Nahrin Gandy, Hayden, ID (US)

(72) Inventors: Donald Douglas Gandy, Hayden, ID (US); Nahrin Gandy, Hayden, ID (US)

(21) Appl. No.: 15/852,638

(22) Filed: Dec. 22, 2017

Related U.S. Application Data
(60) Provisional application No. 62/439,321, filed on Dec. 27, 2016.

(51) Int. Cl. G10G 7/00; G10D 3/00

(52) U.S. Cl. CPC G10G 7/00; G10D 3/00

(57) ABSTRACT

Musical instruments have been covered in ornamentation since the beginning of time. Often, the designs shown on an instrument are an integral part of the performance. However, playing the instrument creates wear. Some wear on the instrument may he desirable, to authenticate that the instrument was used during a performance. However, wear on the back of the instrument may interfere with the functionality of the instrument. For example, wear on the front of a guitar from picking shows authenticity, but scratches on the hack of the guitar may interfere with the resonance chamber. This problem of balancing wear and preservation is a difficult balance to strike. What is needed is a protective attachment that preserves the functionality of the instrument, but allows it to age and demonstrate authenticity.

### BACKGROUND OF THE INVENTION

The present invention relates to a protective attachment to a musical instrument, in some embodiments to a guitar. The present invention prevents wear on the instrument, shows the ornamentation of the instrument, and enables greater freedom of movement of the instrument than previous solutions.

Musical instruments have been covered in ornamentation since the beginning of time. Often, the designs shown on an instrument are an integral part of the performance. However, playing the instrument creates wear. For example, the clothing of the performer may wear on the back of the instrument. Buckles or buttons may scratch the instrument. During vigorous performances, the performer may sweat onto the back of the instrument. Some wear on the instrument may be desirable, to authenticate that the instrument was used during a performance. However, this wear is typically desired on the front of the instrument. Wear on the back of the instrument may interfere with the functionality of the instrument. For example, wear on the front of a guitar from picking shows authenticity, but scratches on the back of the guitar may interfere with the resonance chamber. This problem of balancing wear and preservation is a difficult balance to strike. What is needed is a protective attachment that preserves the functionality of the instrument, but allows it to age and demonstrate authenticity.

Prior solutions to this problem have relied on adhesives, sleeves, or other solutions that strike the improper balance. Adhesives actually accelerate the wear on an instrument through the use of chemicals. Sleeves cover the ornamentation of the instrument, detracting from the pageantry of a performance. These solutions lack the advantages of showing the front of the instrument, while protecting the back of the instrument without physically adhering to the instrument. With prior solutions, a musician must choose between showing the artistry of his instrument, or preserving his most important investment.

### SUMMARY OF THE INVENTION

The present invention relates to devices and systems for the protection of musical instruments from damage caused by scratching, denting, regular wear and tear, and other minor or major actions that may adversely impact the back of the musical instrument. In one embodiment, the present invention is an attachment to a musical instrument that preserves the functionality of the instrument While showcasing the ornamentation of the instrument.

### BRIEF DESCRIPTION OF THE DRAWINGS

For a better understanding of the present invention, and to show more clearly how it is configured and functions, reference will now be made, by way of example, to the accompanying drawings. The drawings show embodiments of the present invention in which:

FIG. 1 is a front view of the musical instrument protector for an electric guitar.

FIG. 2 is a back view of the musical instrument protector for an electric guitar.

FIG. 3 is a front view of the musical instrument protector for an acoustic guitar.

FIG. 4 is a back view of the musical instrument protector for an acoustic guitar.

FIG. 5 is a close view of the frictionally adherent elements of the musical instrument protector.

FIG. 6 is an isolated view of the attachment means for the musical instrument protector that connects to the portion of a guitar body near the neck, from the back view of the musical instrument protector.

FIG. 7 is an isolated view of the attachment means for the musical instrument protector that connects to the portion of a guitar body near the neck with the adjustable securing means exposed, from the back view of the musical instrument protector.

FIG. 8 is an isolated view of the construction of the attachment means for the musical instrument protector that connects to the portion of a guitar body near the neck, from the front view of the musical instrument protector.

FIG. 9 is an isolated view of the construction of the attachment means for the musical instrument protector that connects to the portion of a guitar body near the neck, from the hack view of the musical instrument protector

FIG. 10 is an isolated view of the attachment means for the musical instrument protector that connects to the portion of the guitar body opposite the neck.

FIG. 11A is a side view of the guitar straps pins that may form part of the attachment means.

FIG. 11B is a top view of the guitar strap pins that may form part of the attachment means.

FIG. 11C is a top view of the guitar strap pins that may form part of the attachment means.

### DESCRIPTION

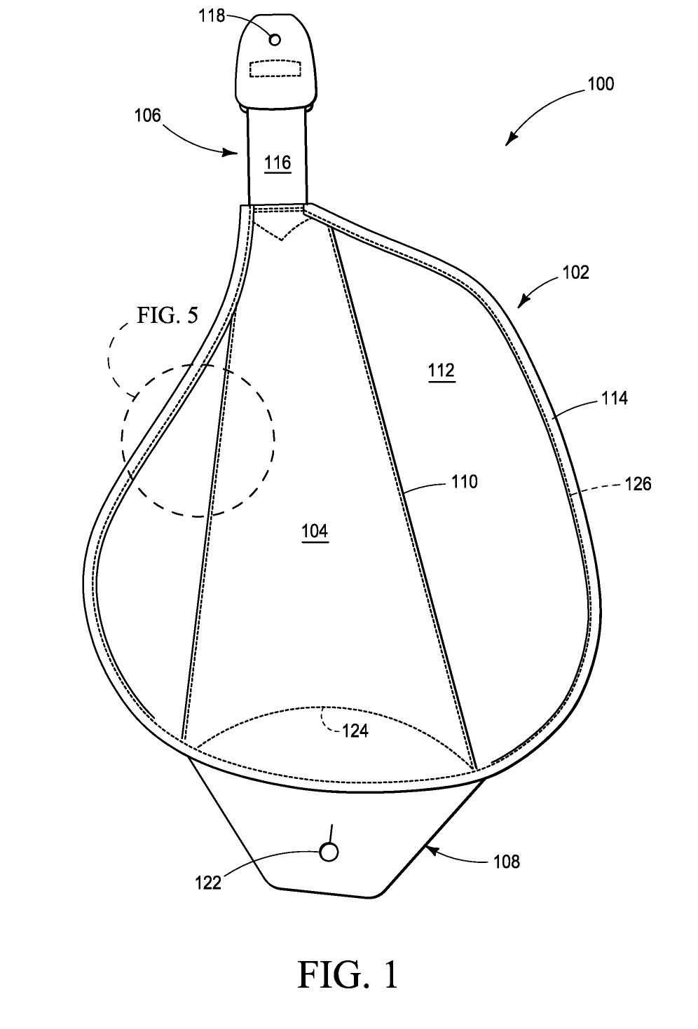

A musical instrument protector 100 according to one embodiment of the present invention is shown in FIG. 1. Generally, the musical instrument protector 100 may be constructed from various soft materials that can be cut and joined, stitched or otherwise attached. in different patterns, and that has at least some stretchable characteristics. For example, the musical instrument protector 100 may be constructed of fabric or fabric-like materials, such as neoprene, cotton, nylon, polyester, leather, or vinyl. The musical instrument protector 100 is configured to mimic the shape of the musical instrument. However, the musical instrument protector 100 is configured to be slightly smaller than the body of the musical instrument, such that the musical instrument protector 100 is not visible when attached to the musical instrument, except at the attachment means, described below.

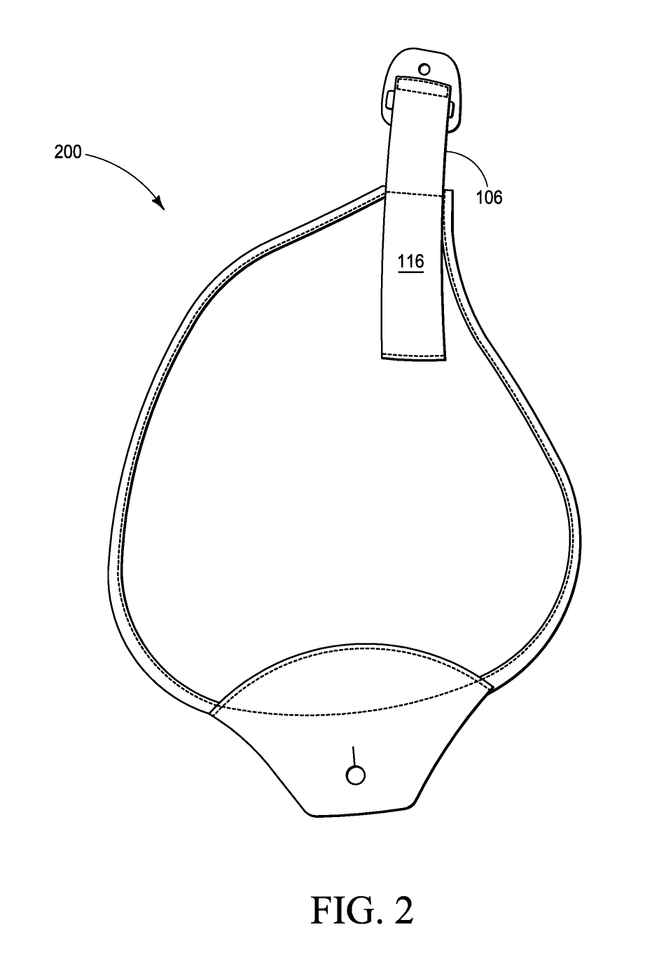

The following elements comprise the musical instrument protector 100: a body portion 102, a frictionally adherent portion 104, a first attachment means 106, and a second attachment means 108. The body portion 102 comprises a front portion 110 that includes the frictionally adherent portion 104, a non-adherent portion 112, and an edge 114. The body portion also includes a hack portion, described below in reference to FIG. 2.

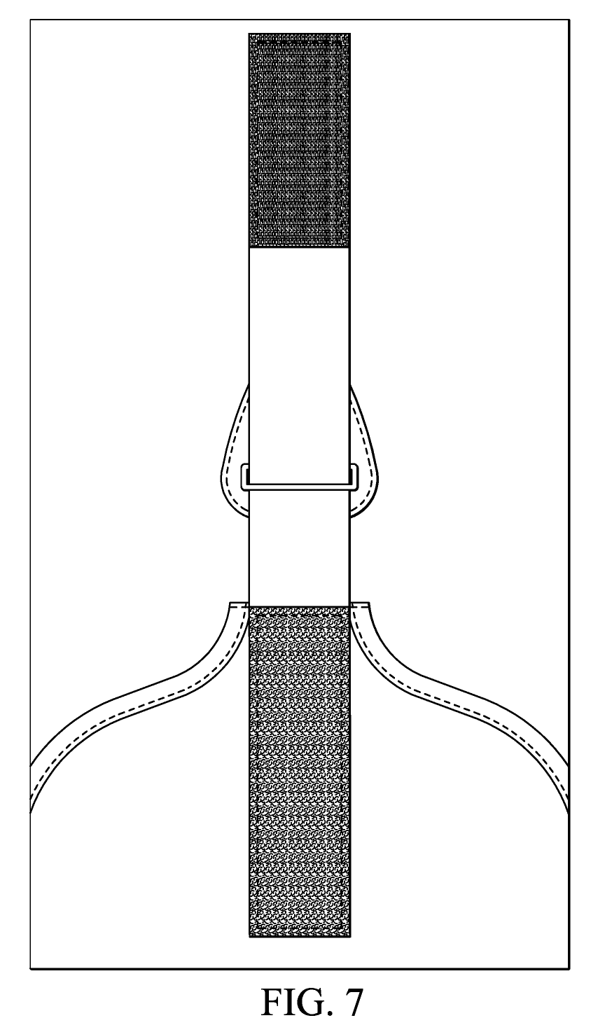

The first attachment means 106 may include an adjustable length means 116 and a first strap pin connector portion 118. The first strap pin connector portion 118 may comprise leather or similar material. The adjustable length means 116 may include adjustable securing means, described below in reference to FIGS. 2, 6, and 7. The adjustable length means 116 may comprise a strap that runs through a buckle, with the adjustable securing means comprising Velcro™. The adjustable length means 116 may comprise polypropylene, and may have a width of approximately two inches. This width may vary, including a range of widths from one to three inches. The first attachment means 106 may be secured to the body portion via stitching 120.

The second attachment means 108 is optionally not adjustable in size. The second attachment means 108 includes a second strap pin connector portion 122. The second attachment means 108 may comprise leather or similar material. The second attachment means may be secured to the body portion 102 via stitching 124. Stitching 124 may run the whole edge of the second attachment means 108. Alternatively, stitching 124 may be secured to the body portion 102 at a plurality of points along the edge of second attachment means. In an alternative embodiment, second attachment means 108 includes a similar construction to first attachment means 106, including an adjustable strap with adjustable securing means.

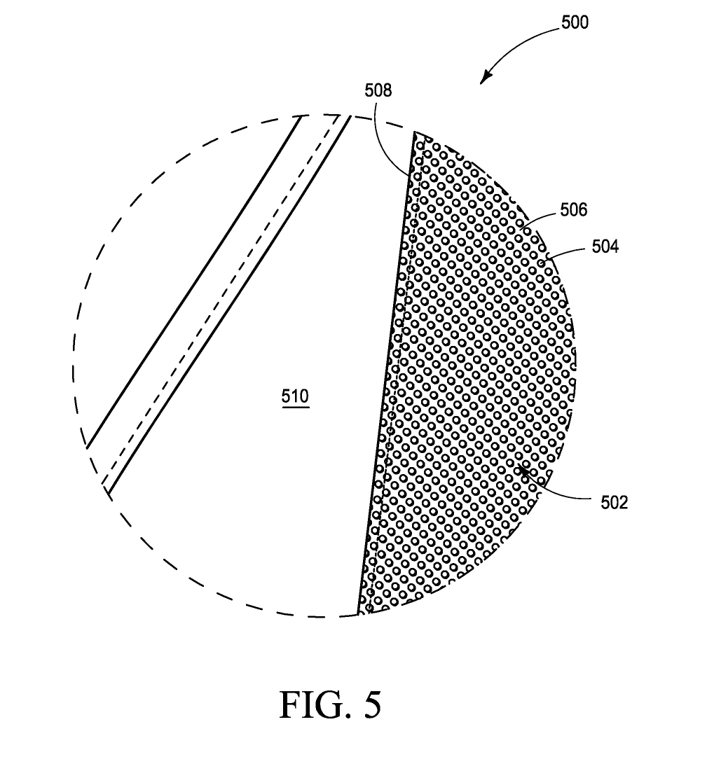

The non-adherent portion 112 of the body portion 102 may be composed of non-abrasive material, such as felt or 600D polyester with PVC coating or similar materials. The edge 114 may be composed of a portion of the back portion, folded over the edge of the front portion 110, such that the edge 114 may contain stitching 126 that secures the front portion 110 and the back portion together. The edge 114 may comprise auto headliner material. Between the front portion 110 and the back portion is a padding portion (not pictured). The padding portion may be composed of polyester foam, or other padding material known to those in the art. In an alternative embodiment, the edge 114 may he a separate piece from the front portion 110 and the back portion. The frictionally adherent portion 104 is described in more detail below in reference to FIG. 5.

FIG. 2 shows the back portion 200 of the body portion 102 of the musical instrument protector 100. From this perspective, adjustable length means 116 is more visible. By attaching adjustable length means 116 on the back portion 200 of the musical instrument protector 100, additional surface area is reserved on the front portion 110 for the frictionally adherent portion 104. Further, by attaching adjustable length means 116 on the back portion 200 of the musical instrument protector 100, as much of first attachment means 106 is hidden from the front perspective as possible. The back portion 200 of the body portion 102 is composed of material that will not catch on the clothing of the user. The back portion 200 may be composed of any material that has the property of allowing freedom of movement of the musical instrument. For example, the material on the back portion 200 may he automobile headliner material.

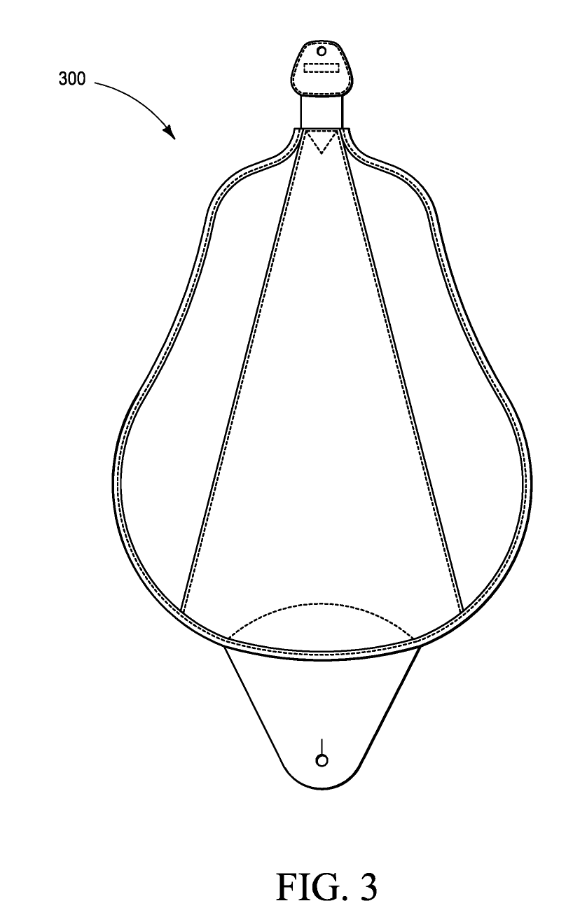

FIG. 3 is a view of the front portion 110 of the musical instrument protector 100 for an alternative embodiment. 3 has different measurements than the embodiment shown in FIG. 1, such that FIG. 3 is constructed to be used with an acoustic guitar, while FIG. 1 is constructed to be used with an electric guitar. While FIGS. 1 and 3 show the musical instrument protector 100 and 300 in the context of a guitar as the musical instrument, the present invention contemplates other musical instruments, including but not limited to basses, banjos, lutes, dulcimers, sitars, rebabs, mandolins, ukuleles, bouzoukis, and variations thereof FIG. 3 has substantially similar elements FIG. 1.

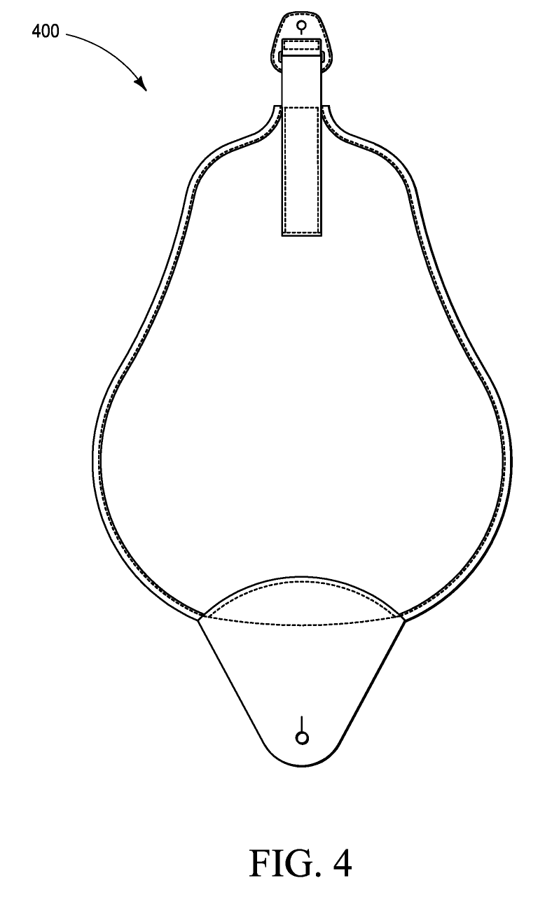

FIG. 4 a view of the back portion 400 of the musical instrument protector 100 for an alternative embodiment. FIG. 4 has different measurements than the embodiment shown in FIG. 2, such that FIG. 4 is constructed to be used with an acoustic guitar, while FIG. 2 is constructed to he used with an electric guitar. FIG. 4 has substantially similar elements FIG. 2.

FIG. 5 is a close view 500 of the frictionally adherent portion 104 of the body portion 102. Frictionally adherent portion 502 is composed of any material that creates tension with the back of a musical instrument, preferably without rubbing or scraping the back of the musical instrument. Optionally, frictionally adherent portion may he composed of Tough Tek Slip™ Frictionally adherent portion 504 creates adherence of the musical. instrument protector 500 without physically attaching to the musical instrument or chemical adhering to the musical instrument. Prior art solutions use chemicals that attach to the musical instrument, or physical connections with the musical instrument. Conversely, frictionally adherent portion 502 utilizes the friction created by the structure of the dimples 504 to adhere the body portion 102 to the musical instrument without damaging the musical instrument. The dimples 504 create surface tension that holds the body portion 102 and the musical instrument together. Dimples 504 are 1 mm or less in height. Dimples 504 are separated from each other by space 506, such that each dimple creates a separate contact point with the musical instrument. Dimples 504 may he circular in shape, or may have any other configuration that similarly aids in creating surface tension. The dimples 504 and space 506 aid in the creation of surface tension, such that they perform better than a flat construction of similar material. The dimples 504 and space 506 create more grip, or friction, than a flat construction of similar material, Frictionally adherent portion 502 preserves the resonance and sound of musical instruments over prior art solutions. For example, frictionally adherent portion 502 contains no mechanical portions that rattle or chemically adhesives that corrode the resonance chamber. Musical instrument protector 100 further is easily detached, such that special cases or equipment is not needed for transportation of the musical instrument. Prior art solutions require additional space in a case, or time-consuming detachment operations to remove the protective solutions, Frictionally adherent portion 504 enables the musical instrument protector 100 to protect the musical instrument while being played, and then to be put away, such that the musical instrument may he, for example, displayed as an art piece while not being used.

Seam 508 separates non-adherent portion 510 from the frictionally adherent portion 502, and aids in securing frictionally adherent portion 502 to the body portion 102. Seam 508 may include stitching or other securing means. Seam 508 may also aid in the frictional adherence of frictionally adherent portion 502. Frictionally adherent portion 502 is sufficiently stiff to prevent the body portion 102 from folding or otherwise changing shape or developing creases.

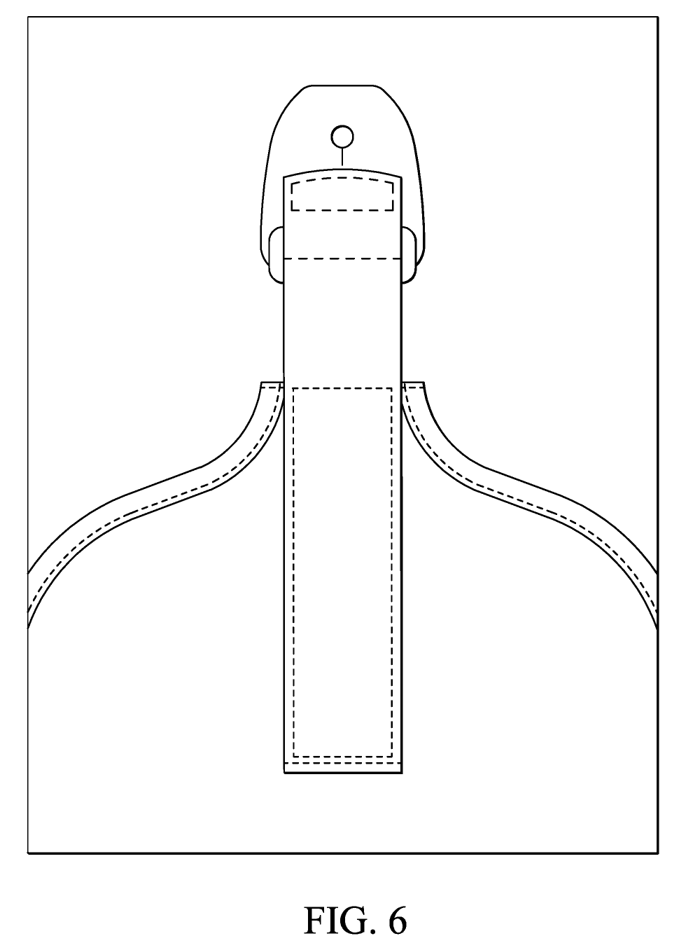

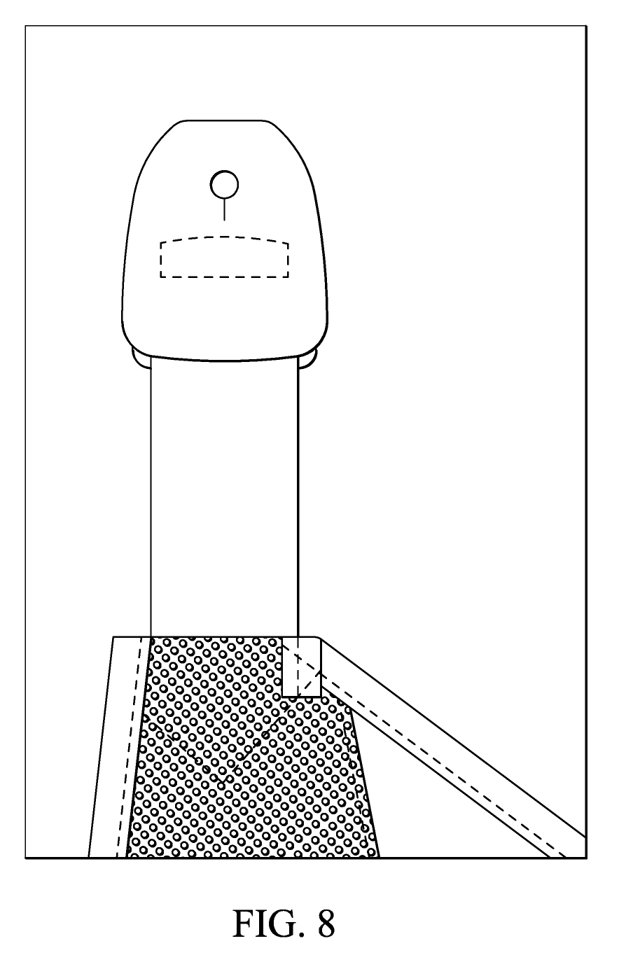

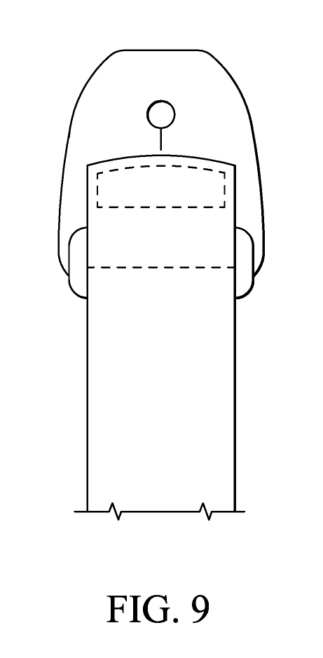

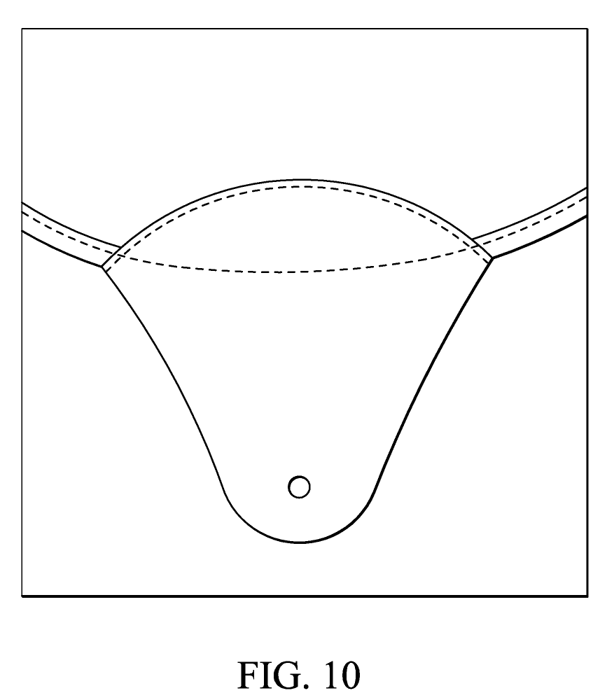

FIGS. 6-10 show additional details of first attachment means 106 and second attachment means 122. FIGS. 6-10 show a particular configuration of the stitching used in attaching first attachment means 106 and second attachment means 122 to the body portion 102.

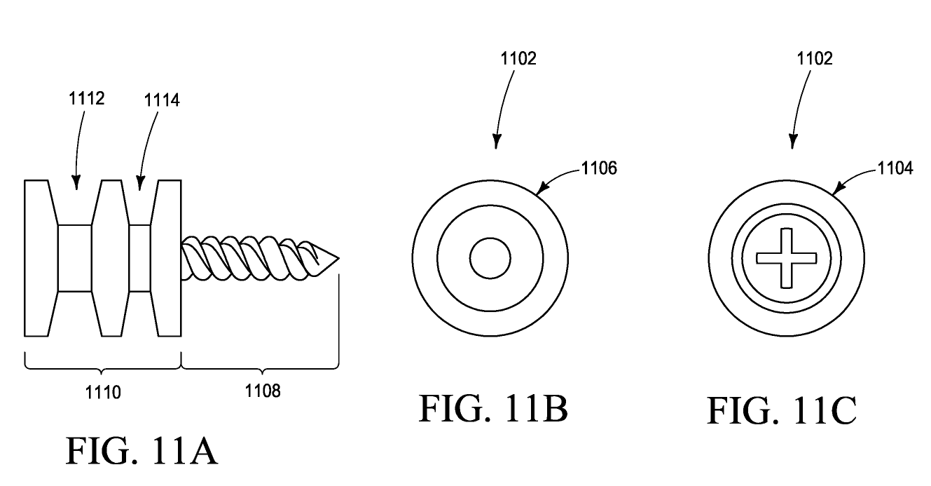

FIG. 11A shows a side view of guitar strap pins that may be used with first attachment means 106 and second attachment means 122 to secure the musical instrument protector 100 to the musical instrument. Guitars and similar musical instruments typically have guitar strap pins that are used to attach a guitar strap to the musical instrument. Here, a particular screw design is shown that may be used to attach a musical instrument to the musical instrument protector 100 through first strap pin connector portion 118 and second strap pin connector portion 122.

FIGS. 11B and C show a top view of guitar straps pins that may be used with first attachment means 106 and second attachment means 122 to secure the musical instrument protector 100 to the musical instrument. Screw top 1102 may have various configurations. For example, screw top 1102 may be configured with a crosshead, or phillips head, 1104, with a pin or otherwise without a head 1106, or with a flat head (not shown). The total screw length may be one and one quarter inches, with eleven sixteenths of an inch of the screw length being the screw body 1108 and nine sixteenths of an inch of the screw length being the screw head 1110. Screw head 1110 may include two slots 1112 and 1114 having a diameter less than that of the screw top 1102. Slots 1112 and 1114 may be present around the entire circumference of screw head 1110. Slots 1112 and 1114 may also comprise less than the entire circumference, such that a portion of slots 1112 and 1114 are even with the face of the screw top 1102. Slot 1112 may be three sixteenths of an inch in height, while slot 1114 may be two sixteenths of an inch in height.

Slots 1112 and 1114 enable the musical instrument protector to be attached to the guitar or other musical instrument, and also enable a guitar strap to be attached. In one embodiment, slot 1114 houses first strap pin connector portion 118 or second strap pin connector portion 122. Slot 1112 then houses a guitar strap. Alternatively, slot 1112 houses first strap pin connector portion 118 or second strap pin connector portion 122. Slot 1114 then houses a guitar strap.

While the fundamental novel features of the invention have been shown and described, it should be understood that various substitutions, modifications, and variations may be made by those skilled in the arts, without departing from the spirit or scope of the invention. For example, when referring to stitching, the present invention contemplates any securing means known to those of skill in the art that would be effective for the uses contemplated herein, such as securing various materials with fabric and fabric-like qualities. Accordingly, all such modification or variations are included in the scope of the invention as defined by the claims.

1. An apparatus for protecting a musical instrument and mimic a shape of a back of a musical instrument, comprising:
a body portion including a front portion that has a frictionally adherent portion, a non-adherent portion composed of non-abrasive material, a seam separating the frictionally adherent portion and the non-adherent portion, and an edge, the body portion further including a back portion, and wherein the edge includes a portion of the back portion, folded over the edge of the front portion and stitching that secures the front portion and the hack portion together, and wherein the edge is composed of auto headliner material, and wherein the edge includes a padding portion between the front portion and the hack portion and is composed of polyester foam, and wherein the back portion is composed of auto headliner material, and wherein the frictionally adherent portion is not composed of a chemical adherent or a physical connection, and wherein the frictionally adherent portion includes a series of spacedly arrayed, less than one millimeter high, circular dimples disposed throughout the frictionally adherent portion;
a first attachment means including an adjustable length means including a strap that runs through a buckle and a first strap pin connector portion, wherein the first strap pin connector portion is composed of leather, and wherein the adjustable length means has an adjustable securing means composed of Velcro, and wherein the adjustable length means is composed of polypropylene and has a width selected from a range of one to three inches;
a second attachment means being unadjustable and including a second strap pin connector portion, wherein the second attachment means is composed of leather, and wherein the second attachment means is secured to the body potion by stitching disposed along an edge of the second attachment means;
a first guitar strap pin connecting the musical instrument, a guitar strap, and the first strap pin connector portion; and
a second guitar strap pin connecting the musical instrument, a guitar strap, and the second strap pin connector portion.

2. An apparatus for protecting a musical instrument as claimed in claim 1, and wherein the stitching disposed along the edge of the second attachment means is disposed along the whole edge of the of the second attachment means.

3. An apparatus for protecting a musical instrument as claimed in claim 1, and wherein the stitching disposed along the edge of the second attachment means is disposed at a plurality of points along the edge of the of the second attachment means.

4. An apparatus for protecting a musical instrument as claimed in claim 1, wherein the non-abrasive material is felt.

5. An apparatus for protecting a musical instrument as claimed in claim 1, wherein the non-abrasive material is 600D polyester with PVC coating.

6. An apparatus for protecting a musical instrument as claimed in claim 1, wherein the frictionally adherent portion is composed of Tough Tek Slip.

7. A guitar strap pin, comprising:
a screw top;
a screw head having a diameter less than a diameter of the screw top, and including two slots, each of the slots having a diameter less than a diameter of the screw top and being disposed around the entire circumference of the screw head, a first slot being three sixteenths of an inch in height, and a second slot being two sixteenths of an inch in height, and wherein the screw head is nine sixteenths of an inch.
a screw body being eleven sixteenths of an inch;
and wherein a length of the screw top, the screw head, and the screw body, together measure one and one quarter inches.

8. A guitar strap pin as claimed in claim 7, and wherein the screw top has a crosshead.

9. A guitar strap pin as claimed in claim 7, and wherein the screw top has a flat head.

10. A guitar strap pin as claimed in claim 7, and wherein. the screw top has a pin.

11. A guitar strap pin as claimed in claim 7, and wherein the screw top has a no head.
